(19) United States
(12) Patent Application Publication
(10) Pub. No.: US 2023/0157356 A1
(43) Pub. Date: May 25, 2023

(54) DELIVERY SYSTEM

(71) Applicant: Nicoventures Trading Limited, London (GB)

(72) Inventors: Ping Chou CHEN, London (GB); Tom WOODMAN, London (GB); Sam LAI, London (GB)

(21) Appl. No.: 17/923,012

(22) PCT Filed: May 11, 2021
(86) PCT No.: PCT/GB2021/051122

§ 371 Date: Nov. 3, 2022

(30) Foreign Application Priority Data
May 29, 2020 (GB) 2008120.4

(51) Int. Cl. A24F 40/40; A24F 40/10; A24F 40/50

(52) U.S. Cl. CPC A24F 40/40; A24F 40/10; A24F 40/50

(57) ABSTRACT

A delivery device is disclosed and comprises a housing comprising a vent opening, and a battery received in the housing. A membrane formed from a gas permeable material extends over the vent opening.

### TECHNICAL FIELD

The present specification relates to a delivery system, such as a non-combustible aerosol provision system, or an aerosol-free delivery system.

### BACKGROUND

Smoking articles, such as cigarettes, cigars and the like burn tobacco during use to create tobacco smoke. Attempts have been made to provide alternative delivery systems to these articles by creating products that release compounds without combustion.

Examples of such delivery systems are so-called “heat not burn” products or tobacco heating devices or products, which release compounds by heating, but not burning, a substrate. For example, tobacco heating devices heat an aerosol generating substrate, which may be tobacco or other non-tobacco products which may or may not contain nicotine, to form an aerosol by heating the substrate without burning it.

### SUMMARY

According to an aspect of the invention, there is provided a delivery device comprising: a housing comprising a vent opening, and a battery received in the housing, wherein a membrane formed from a gas permeable material extends over the vent opening.

The membrane may be formed from a material that is substantially impermeable to liquid. It may have a pore size in the region of 0.65μm, a thickness of between 0.11 mm-0.19 mm, and/or a venting capacity of 1900-2400 ml/cm²/min at a pressure of 7 kpa.

The membrane may be mounted,and is preferably glued, to an inner surface of the housing.

The delivery device may comprise a circuit board mounted in the housing and spaced from the membrane.

A membrane support may be positioned between the membrane and the circuit board.

The membrane support may be located on, and is preferably attached to, the circuit board so that it upstands in a direction towards the membrane.

The membrane support may have an upper surface facing the membrane.

The upper surface of the membrane support may be close to, but spaced from, the membrane to form a pressure relief gap between the upper surface and the membrane.

The upper surface of the membrane support may comprise regions that lie in contact with the membrane.

The regions of the upper surface in contact with the membrane lie in contact with at least a part of the periphery of the membrane that lies in contact with the housing.

The membrane support can be made from a resiliently deformable material.

The membrane support may be configured so that it assumes a deformed condition between the circuit board and the membrane, when located in the housing, so that the membrane support applies a biasing force against the membrane to push it against the housing. The membrane support may, effectively, be squashed between the circuit board and the membrane.

An LED may be mounted to the circuit board and positioned beneath the vent opening such that, when active, light from the LED is visible through the membrane extending across the vent opening.

The membrane can be made from, or be coated with, a material that diffuses the light from the LED.

The membrane support can be positioned so that it extends over the LED, and the membrane support may have a recess in which the LED on the circuit board is received.

The membrane support may be made from a light transmitting material, and/or it may have an opening to allow light from the LED to pass through the membrane support.

The delivery device may comprise a substrate aerosolising module including a heater and an aerosolisable substrate, the substrate aerosolising module being configured to aerosolise the substrate in response to a control signal from the control module.

### BRIEF DESCRIPTION OF THE DRAWINGS

Example embodiments will now be described, by way of example only, with reference to the following schematic drawings, in which:

FIG. 1 is a schematic drawing of a device in accordance with an example embodiment;

FIG. 2 is an exploded view of a control module of the device shown in FIG. 1;

FIG. 3 is a cross-sectional view of the assembled control module of FIGS. 1 and 2;

FIG. 4 is an enlarged view of a portion (encircled as X in FIG. 3) of the assembled control module of FIG. 3; and

FIG. 5A to 5C shows a top perspective, side cross-sectional and bottom views, respectively, of the membrane support.

### DETAILED DESCRIPTION

As used herein, the term “delivery system” is intended to encompass systems that deliver at least one substance to a user, and includes: non-combustible aerosol provision systems that release compounds from an aerosol-generating material without combusting the aerosol-generating material, such as electronic cigarettes, tobacco heating products, and hybrid systems to generate aerosol using a combination of aerosol-generating materials.

Embodiments according to the invention provide a delivery system that includes a housing and a battery contained within the housing. The housing has a vent to allow gases to escape from the housing through the vent, thereby preventing a build-up of pressure within the housing in the event that the battery is, for example, damaged.

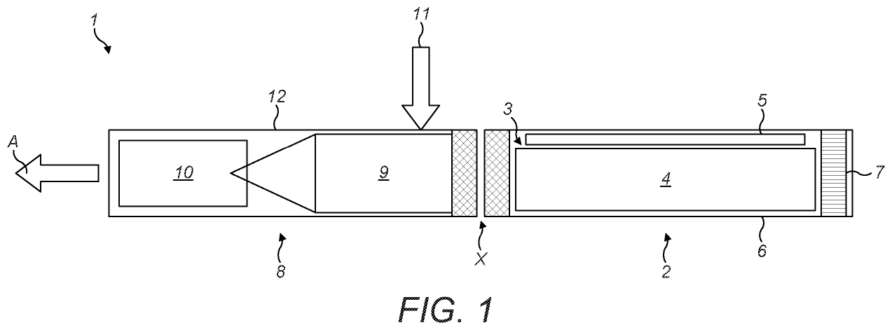

FIG. 1 is a schematic drawing of a delivery system in the form of a non-combustible aerosol provision device, indicated generally by the reference numeral 1, in accordance with an example embodiment. The device 1 comprises two main components 2, 8.

The first component 2 of the device 1 includes a control module 3, which includes a battery 4 and a circuit board 5. The control module 3 is received within a housing 6 which encloses the control module 3 and forms the external appearance of the device. The housing 6 may be a tubular sleeve, in which case the control module 3 is inserted into the housing 6 from one open end during assembly of the device 1 and the open end of the housing 6 is then closed by an end cap 7. However, the housing 6 may, alternatively, be formed from multiple parts or shells that are attached together to form an enclosure around the control module 3. If the housing 6 is formed from two half-shells for instance, the control module 3 may be placed in one half-shell part before the other half-shell part is placed on, and is attached to, the other half-shell part thereby encapsulating the control module 3 within the housing. The housing 6 is preferably formed from a metal, such as aluminium, although other materials for the housing 6 are also possible.

The second component 8 of the device 1 includes a heater 9 and a liquid reservoir 10 that may collectively form an aerosol-generating module. The first and second components 2, 8 may be modular, i.e. the second component 8 may have its own housing 12 and be separable from the first component (at a join marked X in FIG. 1) for repair or replacement. A releasable electrical connection joins the first and second components 2, 8 to enable power and control signals to be transmitted between them. However, the first and second components 2, 8 may not be separable, other than by disassembly of the device 1. More specifically, the first and second components 2, 8 may be connected together during assembly and received within the same integral housing 6 to form an integral unit.

When the device of FIG. 1 is used, air is drawn into an air inlet of the heater 9, as indicated by the arrow 11. The heater 9 is controlled by the control module 3 and heats the incoming air. The heated air is directed to the liquid reservoir 10, where an aerosol is generated. The aerosol exits the device 1 at an air outlet, as indicated by the arrow A, into the mouth of a user of the device 1.

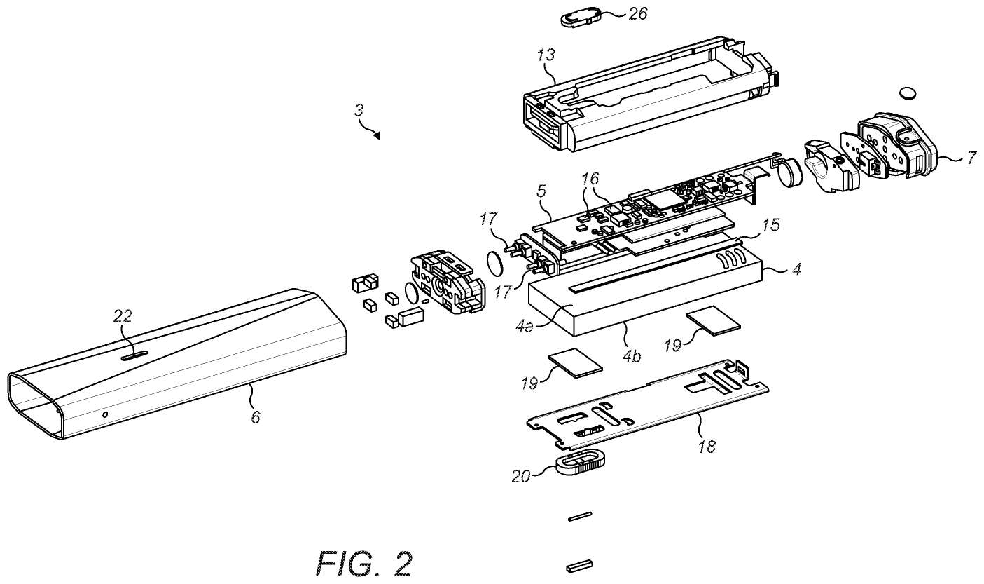

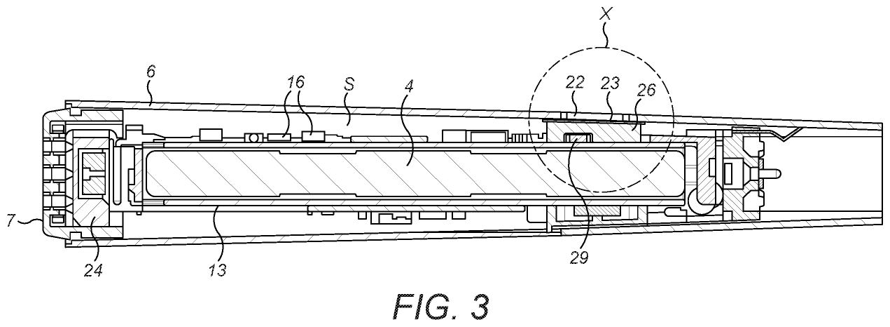

FIG. 2 is an exploded view of the control module 3 shown in FIG. 1, with the second component 8 omitted, and FIG. 3 is a cross-sectional view of the control module 3 of FIG. 2 once assembled and received within the housing 6. In the embodiment of FIG. 2, it can be seen that the housing 6 is in the form of a sleeve and the remaining components of the control module 3 are inserted into the housing 6 from one end. The end is then closed by an end cap 7.

As shown in FIG. 2, and also in FIG. 3 which shows a cross-sectional assembled view of device 1, the control module 3 includes a frame or carrier 13 in which the battery 4 is received and held. A circuit board 5 is mounted to the top, outside surface of the carrier 13 and is supported by both the carrier 13 and by the outside of one major face 4a of the battery 4. An insulated spacer or support pad 15 may be located between the major face 4a of the battery 4 and the circuit board 5 where they overlie each other. The support pad 15 may be adhesive, so that the circuit board 5 is held in place on the major face 4a of the battery 4 by the adhesive pad 15. Various electrical circuit and control elements 16 are mounted to the circuit board 5, which also has connectors 17 for electrical connection of the circuit board 5 to the aerosol generating module of the second component 8. These connectors 17 are positioned on a section of the circuit board 5 that overhangs one end of the carrier 13.

A metal or conductive plate 18 is mounted to the underside of the carrier 13 and to the other major face 4b of the battery 4 on the opposite side of the battery 4 to the circuit board 5. An insulated pad 19 or spacer may be located between the other major face 4b of the battery 4 and the metal plate 18 and may be adhesive so that the metal plate 18 is held in place on the other major face 4b of the battery 4. The metal plate 18 forms an electrical connection between the battery 4 and the circuit and control elements 16 on the circuit board 5. It will be understood that the carrier 13 is open, in the sense that it does not completely cover or surround the battery 4. Even with the circuit board 5 and metal plate 18 mounted to the carrier 13 and extending over the major faces 4a, 4b of the battery 4, the battery 4 is still partially exposed. This enables any heat or gases generated by the battery 4, which may occur either as a result of normal use, or due to a malfunction, to escape into regions of the housing 6 that surround the battery 4, rather than being trapped within the carrier 13.

The control module 3 includes a press button on/off switch 20, which is mounted to the metal plate 18 and is accessible through an aperture in the housing 6. Pressing the on/off switch 20 connects, or disconnects, the battery 4 from the circuitry 16 on the circuit board 5, thereby switching the device on or off, or performing other control functions as required.

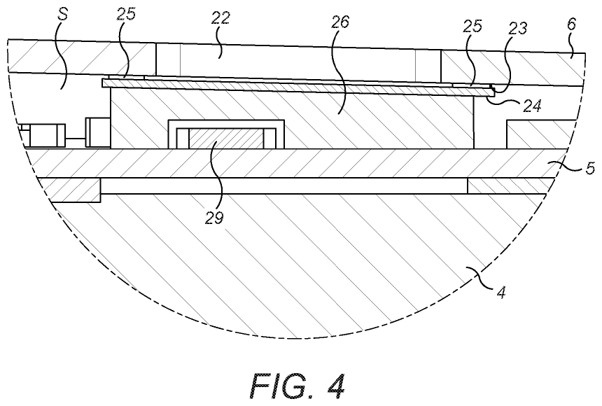

As can be seen most clearly in FIGS. 3 and 4, the carrier 13, together with the battery 4 and circuit board 5 mounted thereto, is received within the housing 6 such that there is a space ‘S’ between the circuit board 5 and the wall of the housing 6 into which heat or gases generated by the battery 4 may dissipate internally. Electrical circuit and control components 16 that are mounted on the circuit board 5 occupy this space.

As the housing 6 is a sealed unit once assembled, gas may collect within the housing 6 resulting in a build-up of pressure. Therefore, a vent 22 is provided through the wall of the housing 6 to enable any gases to escape and to maintain a nominal or atmospheric pressure within the device 1. The vent 22 also allows air to circulate into and out of the housing 6 to minimise any temperature differences.

The vent 22 through which air or other gases can escape from the housing 6 is covered by a membrane 23 which, as a minimum requirement, is sufficiently permeable to allow air and/or gas to pass through it with little or no resistance. However, the membrane 23 may also be waterproof or at least have a degree of water resistance. For example, and with reference to the IP standard drawn up by the International Electrotechnical Commission (IEC), the device 1 may have what is commonly referred to as an ‘IP67 rating’, which means that it is resistant to the seeping of dust or dirt into the device 1, which includes access through the membrane 23. This rating also means that the device 1 can be submerged in fresh water to a depth of up to 1.5 metres for a period of half an hour, without the water penetrating the device 1, and so the membrane 23 covering the vent 22 in the housing 6 needs to be able to prevent such penetration.

To allow for the passage of gas or air, it is envisaged that the membrane 23 may have a hole size of 0.65 μm, and a thickness of between 0.11 mm-0.19 mm, with a venting capacity of 1900-2400 ml/cm²/min at a pressure of 7 kpa. One such material that meets these requirements is made by Dong Guan PUW EPTFE Material Co., LTD., under product no. PUW867.

The membrane 23 is attached to the housing 6 beneath the opening. In particular, the membrane 23 is attached to the inside surface of the housing 6 so that it is recessed from the external surface of the housing 6 by the thickness of the housing 6 making it less accessible and so better protected. Preferably, the membrane 23 is larger than the vent 22 and so has a peripheral region 24 that extends beyond the opening and faces the inside surface of the housing 6. A ring of permanent adhesive 25 is applied to this peripheral region 24 in an annular pattern around the entire peripheral region 24, and attaches the membrane 23 to the housing 6 so that it is held against the housing 6 and extends across the vent 22.

A gap or spacing exists between the circuit board 5 and the membrane 23. Although this gap relatively small, any foreign object or a finger inserted through the vent 22 in the housing 6 and which applies pressure to the membrane 23 may cause the membrane 23 to rupture or the adhesive 25 to fail, resulting in the membrane 23 becoming detached from the housing 6. To prevent or mitigate against these issues, a membrane support 26, shown in its most basic form in FIGS. 3 and 4, may be located between the membrane 23 and the circuit board 5. Preferably, the membrane support 26 is mounted to the circuit board 5 and upstands in a direction towards the membrane 23.

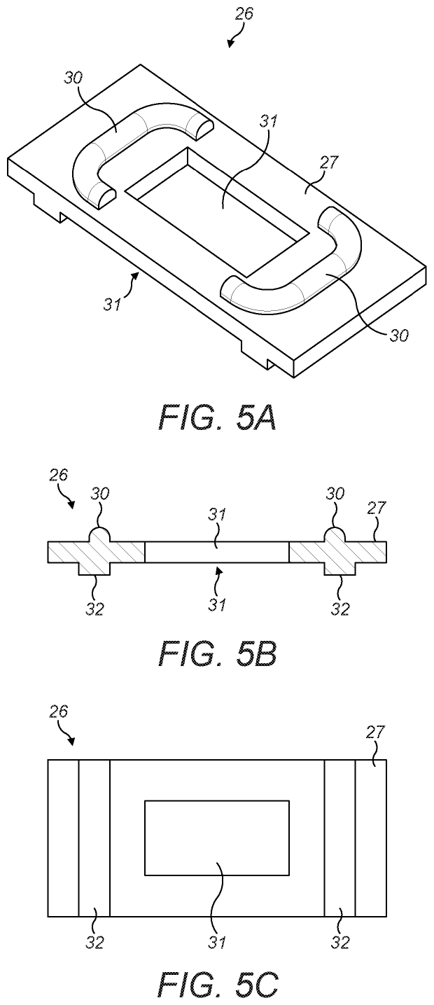

A more detailed version of the membrane support 26 is shown in FIG. 5A to 5C, and from which it can be seen that the membrane support 26 has an upper surface 27 that faces, and which may lie in contact with, the underside of the membrane 23, at least beneath a portion of the membrane 23 which extends across the vent 22. If the upper surface 27 of the membrane support 26 lies in contact with the membrane 23, it may have regions that are not in contact with it so that spaces remain through which gas can pass over the upper surface 27 of the support 26, and through the membrane 23 and vent 22. In particular, and as shown in FIGS. 5A and B, the membrane support 26 may have raised areas 3o upon which the membrane 23 sits. The raised areas 30 form a space between the membrane 23 and the upper surface 27. The raised areas 30 extend about only part of the vent 22 to allow gas to escape between the upper surface 27 and the membrane 23 and pass through the vent 22.

If a membrane support 26 is provided, and pressure is applied to the membrane 23 through the vent 22, the membrane 23 is pressed against, and so supported by, the upper surface 27 or regions 28 of the upper surface 28 of the membrane support 26 with little or no deflection, thereby preventing any damage to the membrane 23 or detachment of the membrane 23 from the housing 6.

The membrane support 26 may be made from a deformable or flexible material, such as rubber, and it may be sized so that, when positioned in the housing 6, it is deformed or squashed between the circuit board 5 and the membrane 23. The membrane support 26 has a degree of resilience such that, once deformed, it applies a force to the membrane 23 that pushes the membrane 23 against the housing 6, i.e. the peripheral region 24 of the membrane 23 which is glued to the housing 6 is pushed against the housing 6 by the membrane support 26. The membrane support 26 therefore also holds the membrane 23 in place, in addition to the adhesive 25. In some embodiments, it may be found that the membrane 23 can be held in place only by the membrane support 26, in which case the membrane 23 need not be glued or otherwise attached to the housing 6. It is also possible for the membrane 23 to be glued or otherwise attached to the membrane support 26 which is then urged against the housing 6 by the deformation and resilience of the membrane support 26. It will be understood that the membrane support 26 resists a degree of pressure if a force is applied to the membrane 23 through the vent 22, prior to any deformation of the membrane support 26.

It will be appreciated, particularly from FIG. 4, that the housing 6 may narrow from one end towards the other. In this instance, the membrane support 26 may also be thinner at one end, i.e. its upper surface 27 may be angled so that it is parallel to the membrane 23 and the housing wall.

It is common for delivery devices 1 to have a light-emitting diode (LED) 29 so that a user can tell if the device is powered, or to signal other functions such as the need for charging of the battery 4. In the majority of known devices, the LED is provided on the circuit board 5 and a window is provided in the housing 6 through which the LED 29 can be seen, or in which the LED 29 is located. In some embodiments of the present invention, the vent 22 is also used as a window through which the LED 29 can be seen, and so provides a dual function, thereby reducing the number of openings that need to be provided in the housing 6. For this purpose, the vent 22 and the LED 29 on the circuit board 5, are positioned so that they are in alignment when the device 1 is assembled. i.e the LED 29 is positioned beneath the vent 22. An LED 29 imounted to the circuit board 5 beneath the vent 22 is shown in FIGS. 3 and 4.

If the vent 22 also provides a window through which the LED 29 is visible, the membrane 23 may additionally have properties that enable it to act as a light guide to diffuse light from the LED 29. In certain embodiments, the membrane 23 may be coated with an optical film, such as a diffuser film or light control film, to improve its performance as a light guide, in addition to having its gas/air permeable properties.

If the LED 29 is positioned beneath the vent 22, then it is possible that the LED 29 may be damaged in addition to, or instead of, the membrane 23, if a foreign object or finger is inserted through the vent 22 and pressure is applied to the membrane 23. Therefore, it is preferable, but not essential, if a membrane support 26 is provided when an LED 29 is present. The membrane support 26 may extend over the LED 29 on the circuit board 5 and may have a recess 31 formed between feet 32 in which the LED 29 is received when the membrane support 26 is mounted to the circuit board 5. The membrane support 26 may be made of a light transmissive material, so that light can pass through it from the LED 29, and through the membrane 23, so that it is visible from outside the housing 6. In addition, or alternatively, the membrane support 26 may have an opening 31 positioned in the vicinity of the LED 29 such that light from the LED 29 can pass through the opening 31, through the membrane 23, and be visible to a user from outside the device 1.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. A delivery device comprising:
a housing comprising a vent opening, and
a battery received in the housing,
wherein a membrane formed from a gas permeable material extends over the vent opening.

2. A delivery device according to claim 1, wherein the membrane is formed from a material that is substantially impermeable to liquid.

3. A delivery device according to claim 1, wherein the membrane has a pore size in the region of 0.65 μm.

4. A delivery device according to claim 1, wherein the membrane has a thickness of between 0.11 mm-0.19 mm.

5. A delivery device according to claim 1, wherein the membrane has a venting capacity of 1900-2400 ml/cm²/min at a pressure of 7 kpa.

6. A delivery device according to claim 1, wherein the membrane is mounted, preferably glued, to an inner surface of the housing.

7. A delivery device according to claim 1, comprising a circuit board mounted in the housing and spaced from the membrane.

8. A delivery device according to claim 7, comprising—a membrane support positioned between the membrane and the circuit board.

9. A delivery device according to claim 8, wherein the membrane support is located on, and preferably attached to, the circuit board and upstands towards the membrane.

10. A delivery device according to claim 9, wherein the membrane support has an upper surface facing the membrane.

11. A delivery device according to claim 10, wherein the upper surface of the membrane support is close to, but spaced from, the membrane to form a pressure relief gap between the upper surface and the membrane.

12. A delivery device according to claim 11, wherein the upper surface of the membrane support comprises regions that lie in contact with the membrane.

13. A delivery device according to claim 12, wherein the regions of the upper surface in contact with the membrane lie in contact at least a part of the periphery of the membrane that lies in contact with the housing.

14. A delivery device according to claim 13, wherein the membrane support is made from a resiliently deformable material.

15. A delivery device according to claim 14, wherein the membrane support is configured so that it assumes a deformed condition between the circuit board and the membrane, when located in the housing, so that the membrane support applies a biasing force against the membrane to push it against the housing.

16. A delivery device according to claim 7, comprising an LED mounted to the circuit board and positioned beneath the vent opening such that, when active, light from the LED is visible through the membrane extending across the vent opening.

17. A delivery device according to claim 16, wherein the membrane is made from, or is coated with, a material that diffuses the light from the LED.

18. A delivery device according to claim 16, when dependent on any of claims 8 to 15, wherein the membrane support is positioned so that it extends over the LED, the membrane support having a recess in which the LED on the circuit board is received.

19. A delivery device according to claim 18, wherein the membrane support is made from a light transmitting material, or has an opening to allow light from the LED to pass through the membrane support.

20. A delivery device according to any preceding claim 1, comprising a substrate aerosolising module including a heater and an aerosolisable substrate, the substrate aerosolising module being configured to aerosolise the substrate in response to a control signal from the control module.
